(19) United States
(12) Patent Application Publication
(10) Pub. No.: US 2016/0214673 A1
(43) Pub. Date: Jul. 28, 2016

(54) BICYCLE SKIRT CLIP

(71) Applicant: CHRISTINE TAYLOR, SAN JOSE, CA (US)

(72) Inventor: CHRISTINE TAYLOR, SAN JOSE, CA (US)

(21) Appl. No.: 14/603,350

(22) Filed: Jan. 22, 2015

(51) Int. Cl. B62J 21/00; A41F 17/02

(52) U.S. Cl. CPC B62J 21/00; A41F 17/02

(57) ABSTRACT

The general purpose of the new bicycle skirt clip is to provide a bicycle rider wearing a dress or skirt the security of having his or her dress or skirt remain in a natural and modest position while riding. The current invention secures the hem of a dress or skirt as to keep the skirt from being blown up or shifted from its desired position.

### BACKGROUND

The general purpose of the new bicycle skirt clip is to provide a bicycle rider wearing a dress or skirt the security of having his or her dress or skirt remain in a natural and modest position while riding. The current invention secures the hem of a dress or skirt as to keep the skirt from being blown up or shifted from its desired position. To date, there exists no device that accomplishes this purpose in the manner and using the elements herein disclosed.

There are a couple of Chinese patents, namely CN 2119378 U and CN 2102876 U, that, at first glance, appear to address the problem that the new invention solves, but these disclosed devices actually involve modification of the bicycle or bicycle seat, which is not a feature of the current invention.

Other skirt-related inventions for bicycle riders focus on preventing entanglement of the skirt with the chain or wheels of the bicycle and do not serve any skirt securing or positioning purpose. Still other inventions target the problem of mud or water being kicked up by the tires while the bike is in use as to prevent a dress or skirt from becoming soiled, but no disclosed invention solves the problem herein addressed.

### SUMMARY OF THE INVENTION

The new bicycle skirt clip is a bicycle accessory to hold down a woman's skirt when riding a bicycle. The skirt clip is universal and attaches to any desirable location on any bike frame when needed by the rider. In general, the skirt clip comprises an adjustable reel housed in plastic, a retractable string with a breakaway feature and metal or plastic tipped clip. When a rider is wearing a skirt or dress, she can simply attach the clip to the hem of her skirt or as desired. The clip holds the skirt down toward the device, yet the retractable string allows for freedom of movement as the rider shifts and adjusts in her seat. If the rider were to have an accident or otherwise abruptly dismount her bicycle, the breakaway engages and the device detaches from the clip and moves back toward the device attached to the bicycle frame. The clip remains on the skirt and can be removed and reattached to the breakaway feature of the device.

### BRIEF DESCRIPTION OF THE DRAWINGS

FIG. 1 illustrates one embodiment of the new bicycle skirt clip whereby an alligator clip; and

FIG. 2 illustrates another one embodiment of the new bicycle skirt clip.

### DETAILED DESCRIPTION OF THE INVENTION

In accordance with this invention, it is now possible for a person riding a bike while wearing a dress or skirt to secure her skirt in a natural, modest position.

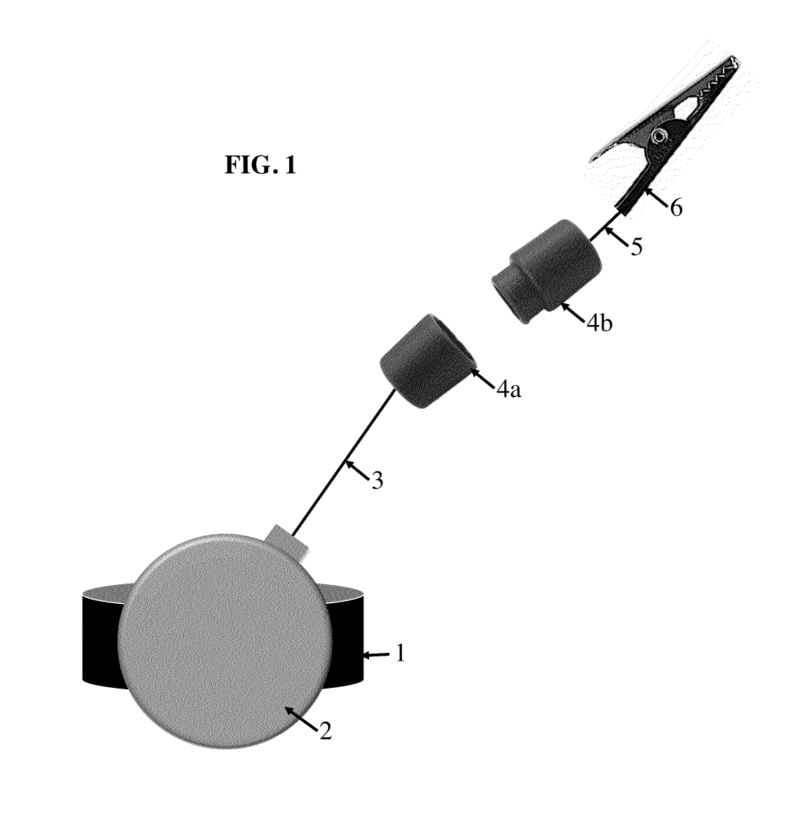

FIG. 1 illustrates one embodiment of the new bicycle skirt clip whereby an alligator clip 6 is attached to a barrel breakaway unit 4a, 4b via an attachment means 5, said breakaway unit being further attached to a retractable cord 3, which is retractably secured at one end within a retractable cord housing 2. The retractable cord housing 2 is secured to an attachment strap 1, which can be positioned on and about a bicycle frame (not shown).

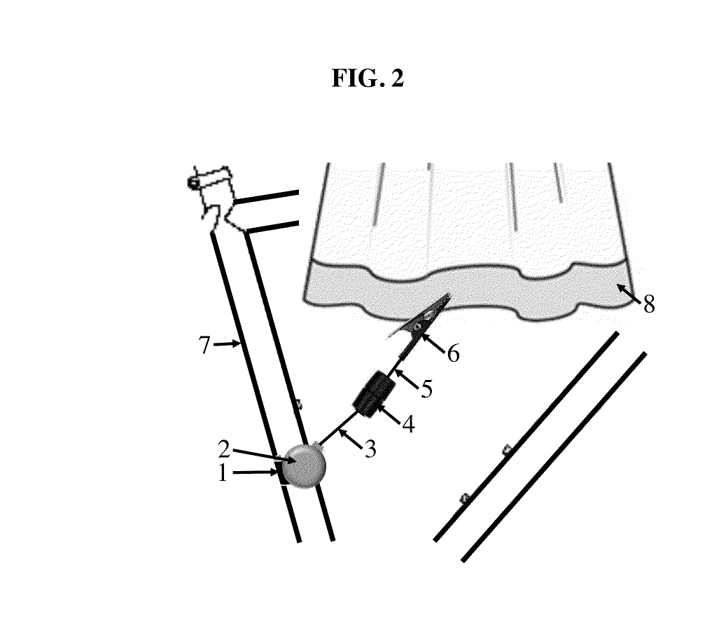

FIG. 2 illustrates another one embodiment of the new bicycle skirt clip where the attachment strap 1 is secured to the frame 7 of a bicycle and the clip 6 is clipped to the hem 8 of a skirt. In use, as shown, the retractable cord 3 is extended from the retractable cord body 2 and connected at the other end to a barrel breakaway unit 4. The breakaway unit 4 is further attached to an alligator clip 6 via an attachment means 5, which may be a cord, loops and eyelets or the like.

The strap 1 may be positioned in any orientation about the bike frame 7 as to enable clipping to a dress or skirt hem 8 as suitable for the rider's needs.

In another embodiment of the invention, the retractable cord body has at least one side projection capable of receiving attachment by an attachment strap that is made of a stretchable material, such as silicone or elastic, said attachment strap having at least two ends with one end being secured to the side of the retractable body and the other end being suitable for looping around said projection when the attachment strap is in a stretched state and, thus, suitable for holding the retractable cord housing body to a bicycle frame.

As to further discussion of the manner of usage and operation of the present invention, the same should be apparent from the above description. With respect to the above description then, it is to be realized that the optimum relationships of the steps of this invention, to include variations in technological enablement, are deemed readily apparent and obvious to one skilled in the art, and all equivalent relationships to those illustrated in the drawings and described in the specification are intended to be encompassed by the present invention, the use of which results in a clip for securing a rider's skirt in a modest position while a rider is riding a bicycle.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided.

What is claimed is:

1. A bicycle skirt clip comprising:
a primary means for attachment to a bicycle, such as a strap of Velcro or silicone, capable of being independently secured to a bicycle frame;
a retractable cord and retractable cord housing having a backside, front side, an axis, a perimeter and a hole positioned on said perimeter in line with said axis, said retractable cord housing attaching to the primary means for attachment via a secondary means for attachment, said retractable cord being retractably housed inside the retractable cord housing and having a tethered end secured within the retractable cord housing via a means for retraction and an untethered end extending from the retractable cord housing through the hole;
a breakaway closure unit having a first end and a second end, the first end being connected to the untethered end of said retractable cord; and
a clip, such as an alligator-style clip, having a connecting end and a clipping end with a hinge and mouth, whereby the connecting end attaches to the second end of the breakaway closure unit and the clipping end is capable of clipping to a garment.

2. The bicycle skirt clip of claim 1, further comprising a rubber guard on both sides of the mouth of the clip as to protect a clipped garment from damage.

3. The bicycle skirt clip of claim 1 wherein
the secondary means for attachment is at least one projection, such as one or more knobs, extending from the perimeter of the retractable cord housing and being generally perpendicular to the axis of the retractable cord housing; and
the primary means for attachment being a strip of stretchable material having a primary end that is secured to the retractable cord housing and one or more secondary ends in number equal to that of said projection(s), said secondary end(s) having a means for securely and reversibly hooking onto said primary end such that the retractable cord housing is reversibly securable to a bike frame.
